(19) United States
(12) Patent Application Publication
(10) Pub. No.: US 2016/0055194 A1
(43) Pub. Date: Feb. 25, 2016

(54) DATA SYNCHRONIZATION MANAGEMENT BETWEEN DEVICES

(71) Applicant: Subodh C. Gupta, Highlands Ranch, CO (US)

(72) Inventor: Subodh C. Gupta, Highlands Ranch, CO (US)

(21) Appl. No.: 14/463,391

(22) Filed: Aug. 19, 2014

(51) Int. Cl. G06F 17/30

(52) U.S. Cl. CPC G06F 17/30356; G06F 17/30368

(57) ABSTRACT

A method, system, and computer readable medium for managing records. The method includes generating and storing, in response to detecting creation of a record, two values for the record, at least a first of the two values indicating a time of the creation of the record. The method also includes updating, in response to detecting a modification of the record, the first value while leaving the second of the two values constant. The method further includes determining, in response to identifying multiple versions of the record, which of the multiple versions of the record is a current version of the record based on the first value. Additionally, the method includes sending data associated with the current version of the record to at least one device not having the current version.

### TECHNICAL FIELD

The present disclosure relates generally to synchronization of data between devices connected over a network. More particularly, the present disclosure relates to managing record versions of data synchronized between devices.

### BACKGROUND

With the modern utilization of networks connecting devices, businesses and persons use multiple devices for business and personal reasons. Data synchronization can provide consistency among data accessed, shared, and modified at different devices. When data is modified at a device, different versions of the data can be created.

Accordingly, it would be advantageous to have systems and methods that take into account one or more of the issues discussed above, as well as possibly other issues.

### SUMMARY

The different illustrative embodiments provide methods, systems, and computer readable media for data synchronization management between devices.

In one exemplary embodiment, a method for managing records is provided. The method includes generating and storing, in response to detecting creation of a record, two values for the record, at least a first of the two values indicating a time of the creation of the record. The method also includes updating, in response to detecting a modification of the record, the first value while leaving the second of the two values constant. The method further includes determining, in response to identifying multiple versions of the record, which of the multiple versions of the record is a current version of the record based on the first value. Additionally, the method includes sending data associated with the current version of the record to at least one device not having the current version.

In another exemplary embodiment, a system for managing records is provided. The system includes at least one storage device configured to store program code, at least one communication unit, and at least one processor. The at least one processor is configured to execute the program code to, in response to detection of creation of a record, generate and store, via the at least one storage device, two values for the record, at least a first of the two values indicating a time of the creation of the record; update, in response to detecting a modification of the record, the first value while leaving the second of the two values constant; determine in response to identifying multiple versions of the record, which of the multiple versions of the record is a current version of the record based on the first value; and send, via the at least one communication unit, data associated with the current version of the record to at least one device not having the current version.

In yet another exemplary embodiment, a non-transitorily computer readable medium comprising program code for managing records is provided. The computer readable medium includes program code for generating and storing, in response to detecting creation of a record, two values for the record, at least a first of the two values indicating a time of the creation of the record. The computer readable medium also includes program code for updating, in response to detecting a modification of the record, the first value while leaving the second of the two values constant. The computer readable medium further includes program code for determining, in response to identifying multiple versions of the record, which of the multiple versions of the record is a current version of the record based on the first value. Additionally, the computer readable medium includes program code for sending data associated with the current version of the record to at least one device not having the current version.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example computing system in which various embodiments of the present disclosure may be implemented;

FIG. 2 illustrates records of data stored in a database in accordance with an illustrative embodiment of the present disclosure;

FIG. 3 illustrates a flowchart of a process for managing records in accordance with an illustrative embodiment of the present disclosure; and

FIG. 4 illustrates a block diagram of a computing device which may be utilized to implement various embodiments of the present disclosure.

### DETAILED DESCRIPTION

The various figures and embodiments used to describe the principles of the present disclosure in this patent document are by way of illustration only and should not be construed in any way to limit the scope of the present disclosure. Those skilled in the art will understand that the principles of the present disclosure may be implemented in any type of suitably-arranged device or system.

Various embodiments of the present disclosure recognize and take into account that the last modified time is often used to determine which version of data is most current. However, in synchronizing data across multiple network connectable devices, there is difficulty in identifying whether the data is a new record or a modification of an existing record. Accordingly, various embodiments of the present disclosure provide methods, systems, and computer readable media for managing record synchronization between network connectable devices.

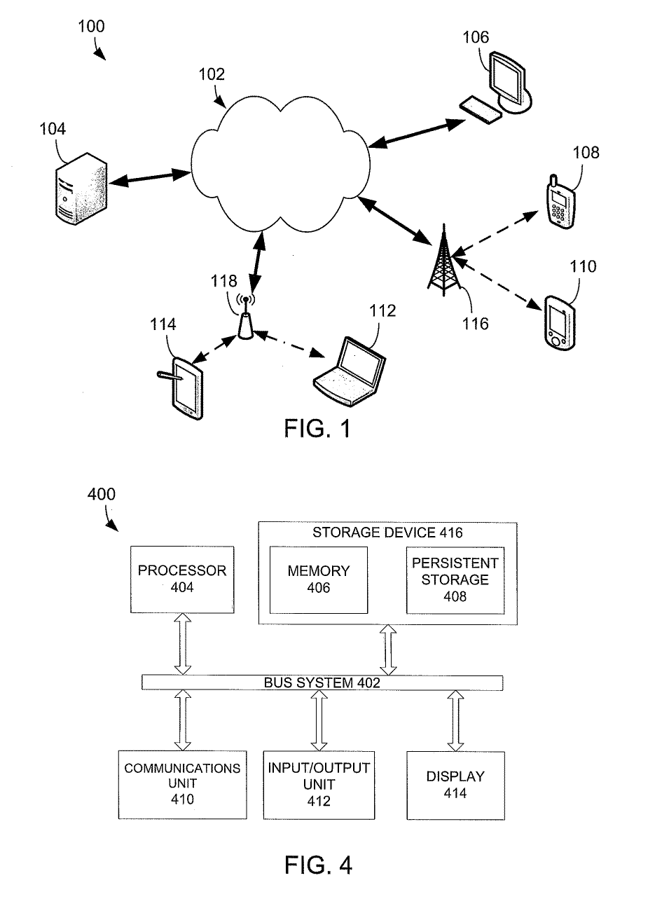

FIG. 1 illustrates an example computing system 100 in which various embodiments of the present disclosure may be implemented. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100. For example, the network 102 may communicate Internet Protocol (IP) packets or other information between network addresses. The network 102 may include one or more local area networks (LANs); metropolitan area networks (MANs); wide area networks (WANs); all or a portion of a global network, such as the Internet; or any other communication system or systems at one or more locations.

The network 102 facilitates communications between at least one server 104 and various client devices 106-114. Each server 104 includes any suitable computing or processing device that can provide computing services for one or more client devices 106-114. Each server 104 could, for example, include one or more processing devices, one or more memories storing instructions and data, and one or more network interfaces facilitating communication over the network 102. For example, in various embodiments, the server 104 may be a structured query language (SQL) cloud server that stores and manages data for applications, such as, for example, a mobile point-of-sale (POS) service. The server 104 may further include a datacenter firewall that provides safety and security for data stored by the server 104. The server 104 may also include a backup system that provides redundancy in the event of data loss by the server 104.

Each client device 106-114 represents any suitable computing or processing device that interacts with at least one server or other computing device(s) over the network 102. In this example, the client devices 106-114 include a desktop computer 106, a mobile telephone or smartphone 108, a personal digital assistant (PDA) 110, a laptop computer 112, and a tablet computer 114. However, any other or additional client devices could be used in the computing system 100.

For example, in various embodiments, the client devices 106-114 may be merchant devices used to enable POS services, such as, for example, sales, marketing, inventory, customer and/or employee, and management. For example, one or more of the client devices 106-114 may be Internet or web based POS devices that provide such POS services in a web connectable device via an application, such as, for example, a web browser, a web application, and/or a dedicated client application. In another example, the one or more of the client devices 106-114 may be mobile POS devices that provide such POS services via a mobile application or “app”.

In this example, some client devices 108-114 communicate indirectly with the network 102. For example, the client devices 108-110 communicate via one or more base stations 116, such as cellular base stations. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

In various embodiments of the present disclosure, the server 104 provides synchronization of data among the client devices 106-114. For example, records of data may be created, accessed, and modified at any of the client devices 106-114. The server 104 stores and maintains the records of the data and provides the data to the client devices 106-114. For an example, the records of data may pertain to user information, such as account information, customer information, employee information, inventory information, contact information; user settings, such as display preferences, menu preferences, etc.; data, such as electronic mail; contact information, such as phone numbers and addresses; data files, such as documents and media; and/or any other type of data that may be created, accessed, and/or modified via network connectable devices.

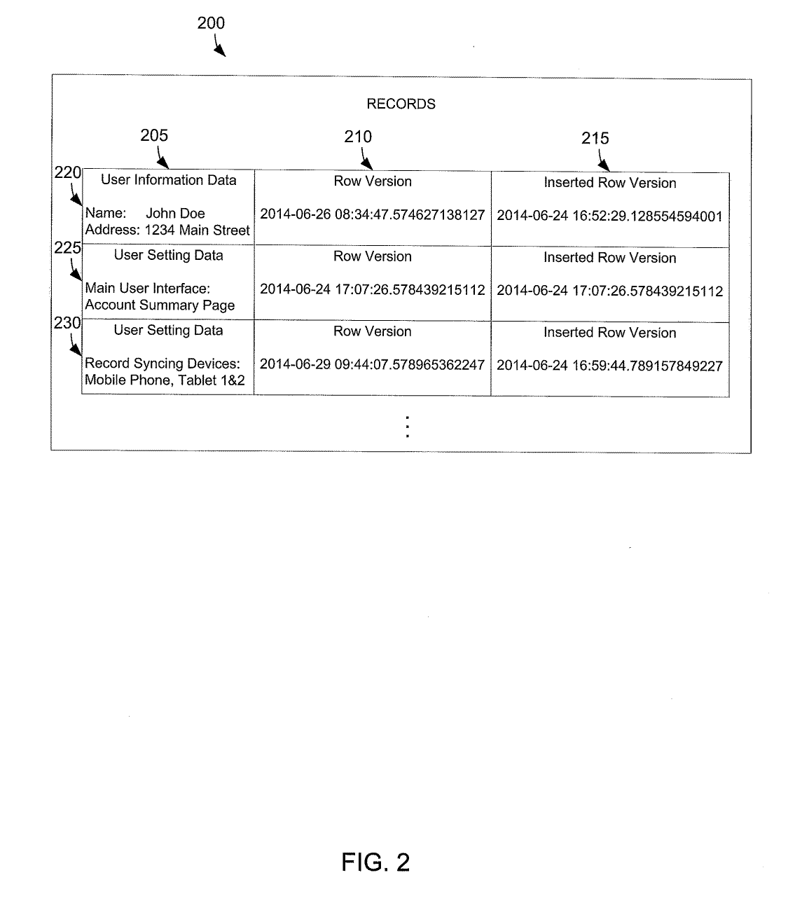

When records are first created by any of the client devices 106-114, two values are created for managing the synchronization and versioning of the data. These values may be created by the server 104 where the records are managed or devices that the record is created by, such as one of the client devices 106-114. In one example, these two values may be called the row version (RV) and inserted row version (IRV). When the record is first created, the two values are set to be the same value. For example, the values may be set to a timestamp of the creation of the record as in the example embodiment illustrated and discussed in greater detail with regard to FIG. 2 below. This timestamp may be based on the time the data for the record is generated by one of the client devices 106-114 or may be the time that the record is saved at the server 104. In some embodiments, the values are globally unique timestamps that are, for example, accurate to the picosecond, so as to insure that that the values for no two different records are the same.

The server 104, after creation of the record, synchronizes the data among devices to be synchronized by sending data for the record to devices not having the data associated with the created record. For example, a user or organization may specify settings for data to be synchronized among a set of devices. When the data record is created, the server 104 sends or “pushes” the data to devices in the set not having the current updated data. In another example, the devices to be synchronized may pull the data at specific intervals or in response to a request for data update or synchronization. In this manner, the user or organization may utilize or be presented with current data at each of the synchronized devices.

Whenever a record is modified, for example, if a user updates information or changes a setting, the server 104 updates a first of the values, for example the RV, while leaving the second value constant, for example the IRV. In this manner, the server 104 is able to track which of the versions of the record is the most current, e.g., the record with the highest first value or latest timestamp in the RV. Additionally, the server 104 is able to identify which record the modification is for based on the second value having remained constant.

In one illustrative example, the device where the modification was made may send a message to the server 104 when the modification is made. This message may include the second constant value, for example, the IRV, the modified data to be synchronized, as well as possibly a timestamp for the modification for the first value. Upon receipt, the server 104 identifies the record that has been modified based on the second value and updates the first value based on, for example, the timestamp of the modification. If, for example, more than one modification were made to data for a record to be synchronized before the synchronization occurred, the server 104 is able to identify the record to which the modification pertains and which of the modifications is most current for synchronization using these two values.

In various embodiments, when a record is first created on a client device, the record may not include either of the two values. Rather, the client device may send an identifier of the device, such as a mobile identification number. When the record is received, the server 104 may generate and store a new record along with the values. The server 104 may send data including one or more of the record values back to the client device confirming successful save of the record so that the client device will not insert a new record for this created record.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

FIG. 2 illustrates records 200 of data 205 stored in a database in accordance with an illustrative embodiment of the present disclosure. For example, the server 104 may store the records 200 in a server database, such as a cloud computing database. Each of the records 200 includes the underlying data 205, such as, for example, user information data and user setting data, as well as two values 210 and 215 for managing the synchronization of the data 205. In this example, the values 210 and 215 are the RV 210 and the IRV 215, respectively, which are picosecond timestamps for the last modification time and creation time of the respective record 200. For example, record 220 includes user information data that has been previously modified. Upon identification of a record modification including the same IRV 215 as record 220, the server 104 identifies this as a modification and not a newly-created record and updates the RV 210. Record 225 has the same value for the RV 210 and the IRV 215. This means that record 225 is a newly-created or unmodified record. Record 230 is user setting data indicating which of the user devices data is to be synchronized among. Such settings may be updated at any of a user or organization device. The server 104 manages such settings and may synchronize data indicative of such modifications.

FIG. 2 is intended as an example and not a limitation on the various embodiments that may be implemented in accordance with the principles of the present disclosure. For example, in various embodiments, the data to be synchronized may be stored at a location that is separate from the location where the RV and IRV values are managed. For example, the server 104 may manage the values, and a separate server or peer-to-peer configuration may be used to synchronize the data. In another example, only the modifications, changes, or delta may be stored and synchronized among devices, for example, to save on storage or network resources. In other examples, additional values beyond only two may be created and stored for each of the records.

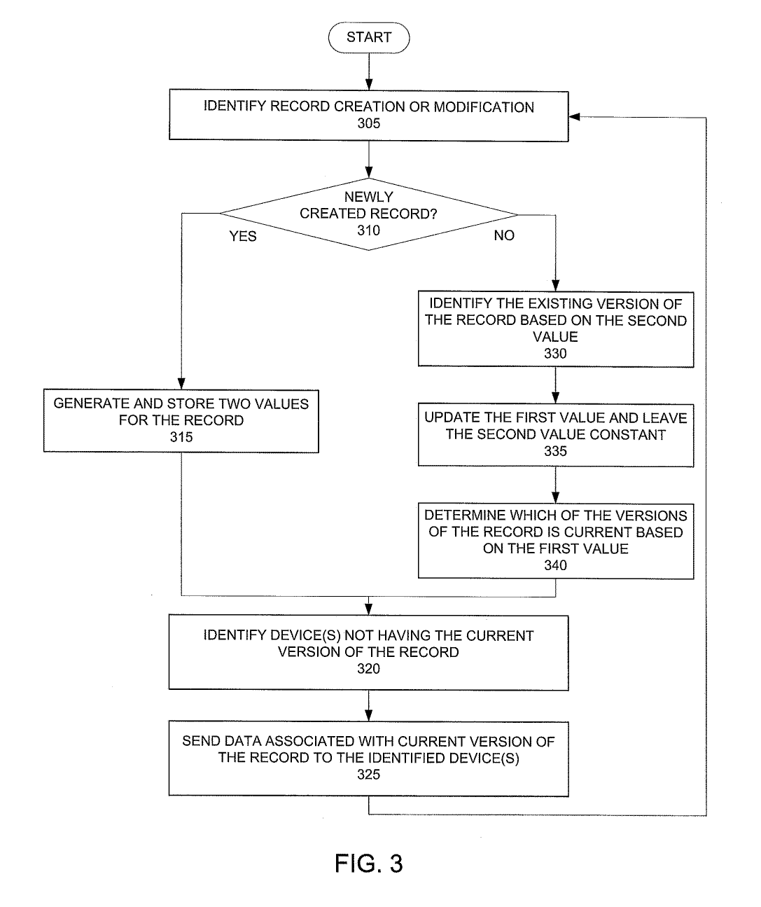

FIG. 3 illustrates a flowchart of a process for managing records in accordance with an illustrative embodiment of the present disclosure. The process illustrated in FIG. 3 may be performed by any of the devices in the system 100 in FIG. 1, for example, the server 104.

The process begins with the system identifying a record creation or modification (step 305). For example, in step 305, the system may receive an indication that data has been generated or modified and that such data is to be recorded for synchronization among a set of devices.

The system determines whether the record is a newly-created record (step 310). For example, in step 310, the system may receive a value with the indication of the record that matches a value of a record stored in a database. In this instance, the system may identify that the record is a modification of an existing record managed by the system. In another example, the system may receive an identifier of the device the record was received from or may only receive a request for a creation of a new record. In this instance, the system may identify that the record is a newly-created record or the first instance or version of the record.

If the system determines that the record is newly created, the system generates and stores two values for the record (step 315). For example, in step 315, the system may generate and store values indicating a time of the creation of the record. The records may be globally unique timestamps that, for the creation of the record, are set to a same value.

Thereafter, the system identifies device(s) not having the current version of the record (step 320). For example, in step 320, the system may manage a list of devices for which records are to be synchronized among and exclude the device that the record creation or modification was received from.

The system then sends data associated with the current version of the record to the identified device(s) (step 325). For example, in step 325, the system may send the updated or created data to device(s) for which records are to be synchronized with and that have not received the updated or created data.

On the other hand, if the system determines that the record is a modification of an existing record, the system identifies the existing version of the record based on the second value (step 330). For example, in step 330, the system may compare the value, e.g., the IRV, received with the notification of the record modification with values stored in a database to identify the existing previous version of the record.

The system then updates the first value and leaves the second value constant (step 335). For example, in step 335, the system may update the first value for the record, e.g., the RV, with a time of the modification of the record and leave the second value for the record, e.g., the IRV, the same.

When multiple versions of a record exist, the system determines which of the versions of the record is current based on the first value (step 340). The system then proceeds with synchronization of the data for the current version of the record in steps 320 and 325. Thereafter, the system returns to step 305 to continue to monitor to identify newly-created records or modifications of existing records for synchronization.

The flowchart and block diagrams in the figures illustrate the architecture, functionality, and operation of various possible implementations of systems, methods, and computer program products according to various illustrative embodiments. In this regard, each block in the flowchart or block diagrams may represent a module, segment, function, and/or a portion of an operation or step. For example, one or more of the blocks may be implemented as program code, in hardware, or a combination thereof. When implemented in hardware, the hardware may, for example, take the form of integrated circuits that are manufactured or configured to perform one or more operations in the flowcharts or block diagram.

In some embodiments, the function or functions noted in the block may occur out of the order noted in the figures. For example, in some cases, two blocks shown in succession may operate substantially concurrently, or the blocks may sometimes be executed in the reverse order, depending upon the functionality involved. Also, other blocks may be added in addition to the illustrated blocks in a flowchart or block diagram.

FIG. 4 illustrates a block diagram of a computing device 400, which may be utilized to implement various embodiments of the present disclosure. In this example, the computing device 400 includes a bus system 402, which supports communication between a processor 404, a memory 406, a persistent storage 408, a communications unit 410, an input/output (I/O) unit 412, and a display 414. In these illustrative examples, computing device 400 is an example of one implementation of server 104 and client devices 106-114 in FIG. 1.

The processor 404 executes instructions that may be loaded into a memory 406. The processor 404 may include any suitable number(s) and type(s) of processors or other devices in any suitable arrangement. Example types of processor 404 include microprocessors, microcontrollers, digital signal processors, field programmable gate arrays, application specific integrated circuits, and discrete circuitry.

Memory 406 and persistent storage 408 are examples of storage device 416, which represent any structure(s) capable of storing and facilitating retrieval of information (such as data, program code, and/or other suitable information on a temporary or permanent basis). The memory 406 may represent a random access memory or any other suitable volatile or non-volatile storage device(s). The persistent storage 408 may include one or more components or devices supporting longer-term storage of data, such as a read-only memory, magnetic tape, hard drive, RAM (Random Access Memory), flash memory, or optical disc (such as CD, DVD, or BluRay).

Communications unit 410 provides for communications with other data processing systems or devices. In these examples, communications unit 410 may include a wireless (cellular, WiFi, WiMAX, Bluetooth, etc.) transmitter, receiver and/or transmitter, a network interface card, and/or any other suitable hardware for sending and/or receiving communications over a physical or wireless communications medium. Communications unit 410 may provide communications through the use of either or both physical and wireless communications links.

Input/output unit 412 allows for input and output of data with other devices that may be connected to computing device 400. For example, input/output unit 412 may provide a connection for user input through a keyboard, a mouse, a tablet, an appropriately configured monowheel “IT”, and/or some other suitable input device. Further, input/output unit 412 may send output to a printer.

Input/output unit 412 allows for input and output of data with other devices that may be connected to or a part of the computing device 400. For example, input/output unit 412 may provide a connection for user input through a keyboard, a mouse, an external microphone, and/or some other suitable input/output device. In some embodiments, input/output unit 412 may include a touch panel to receive touch user inputs, a microphone to receive audio inputs, a speaker to provide audio outputs, and/or a motor to provide haptic outputs. Further, input/output unit 412 may send output to a printer.

Display 414 provides a mechanism to display information to a user. In some embodiments, the display 414 may be a touch screen implemented in connection with the input/output unit 412. In other embodiments, the display 414 may be external to the computing device 400 and connectable via a cable or over a network connection, for example.

Program code for an operating system, applications, or other programs may be located in storage device 416, which is in communication with the processor 404 through the bus system 402. In some embodiments, the program code is in a functional form on the persistent storage 408. These instructions may be loaded into memory 406 for processing by processor 404. The processes of the different embodiments may be performed by processor 404 using computer-implemented instructions, which may be located in memory 406. For example, processor 404 may perform processes for one or more of the modules and/or devices described above.

In some embodiments, various functions described above are implemented or supported by a computer program product that is formed from computer-readable program code and that is embodied in a computer-readable medium. Program code for the computer program product may be located in a functional form on a computer-readable storage device that is selectively removable and may be loaded onto or transferred to computing device 400 for processing by processor 404. In some illustrative embodiments, the program code may be downloaded over a network to persistent storage 408 from another device or data processing system for use within computing device 400. For instance, program code stored in a computer-readable storage medium in a server computing device may be downloaded over a network from the server to computing device 400. The computing device providing program code may be a server computer, a client computer, or some other device capable of storing and transmitting program code.

As will be appreciated by one skilled in the art, aspects of the present disclosure may take the form of a computer program product embodied in one or more computer-readable storage medium(s) having program code embodied thereon. A computer-readable storage medium may be, for example, without limitation, a portable computer diskette, a hard disk, a random access memory (RAM) or derivations thereof, a read-only memory (ROM) or derivations thereof, an erasable programmable read-only memory (EPROM or Flash memory), a portable compact disc read-only memory (CD-ROM), an optical storage device, a magnetic storage device, a collection of qubits, or any suitable combination of the foregoing. The program code may also be loaded for execution by a processor to provide processes for implementing the functions or operations described in the present disclosure.

Various embodiments of the present disclosure provide data synchronization among network connectable devices. Embodiments of the present disclosure generate and manage two globally unique values for records of data to be synchronized. In using one value which is indicative of the initial creation time for the record and a second which is indicative of a latest modification time for the record, embodiments of the present disclosure efficiently manage storage of records, handle conflicts between different versions of the same record, and distribute the current and correct version of the record to the devices in the set to be synchronized among.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following: A, B, and C; A and B; A and C; B and C; A; B; and C.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing records, the method comprising:
in response to detecting creation of a record, generating and storing two values for the record, at least a first of the two values indicating a time of the creation of the record;
in response to detecting a modification of the record, updating the first value while leaving the second of the two values constant;
in response to identifying multiple versions of the record, determining which of the multiple versions of the record is a current version of the record based on the first value; and
sending data associated with the current version of the record to at least one device not having the current version.

2. The method of claim 1, further comprising:
determining whether the record is a newly created record or a modification of an existing record based on whether the two values for the record have a same value; and
in response to determining that the record is a modification of the existing record, identifying the existing record based on the second value.

3. The method of claim 1, wherein generating the two values for the record comprises generating the two values as globally unique timestamps that, for the creation of the record, are set to a same value.

4. The method of claim 1, wherein updating the first value comprises indicating a time of the modification of the record the record in the updated first value.

5. The method of claim 1, further comprising:
in response to detecting the creation of the record, identifying a user device on which the record was created and saving the record; and
after generating the two values for the record, sending a confirmation of the record being saved to the identified user device.

6. The method of claim 1, wherein sending data associated with the current version of the record to at least one device not having the current version comprises:
determining at least one other user device for which records are to be synchronized with, and
sending data associated with the record to the at least one other user device.

7. The method of claim 1, wherein the record is for at least one of a user setting, an electronic mail message, contact information, or user information.

8. A system for managing records, the system comprising:
at least one storage device configured to store program code;
at least one communication unit; and
at least one processor configured to execute the program code to:
generate, in response to detection of creation of a record, and store, via the at least one storage device, two values for a record, at least a first of the two values indicating a time of the creation of the record;
update, in response to detecting a modification of the record, the first value while leaving the second of the two values constant;
determine, in response to identifying multiple versions of the record, which of the multiple versions of the record is a current version of the record based on the first value; and
send, via the at least one communication unit, data associated with the current version of the record to at least one device not having the current version.

9. The system of claim 8, wherein the at least one processor is further configured to execute the program code to:
determine whether the record is a newly created record or a modification of an existing record based on whether the two values for the record have a same value; and
in response to determining that the record is a modification of the existing record, identify the existing record based on the second value.

10. The system of claim 8, wherein in generating the two values for the record, the processor is further configured to execute the program code to generate the two values as globally unique timestamps that, for the creation of the record, are set to a same value.

11. The system of claim 8, wherein in updating the first value, the processor is further configured to execute the program code to indicate a time of the modification of the record the record in the updated first value.

12. The system of claim 8, wherein the processor is further configured to execute the program code to:
identify, in response to detecting the creation of the record, a user device on which the record was created and saving the record; and
after generating the two values for the record, send, via the at least one communication unit, a confirmation of the record being saved to the identified user device.

13. The system of claim 8, wherein in sending, via the at least one communication unit, data associated with the current version of the record to at least one device not having the current version, the processor is further configured to execute the program code to:
determine at least one other user device for which records are to be synchronized with, and
send, via the at least one communication unit, data associated with the record to the at least one other user device.

14. The system of claim 8, wherein the record is for at least one of a user setting, an electronic mail message, contact information, or user information.

15. A non-transitory computer readable medium comprising program code for managing records, the computer readable medium comprising program code for:
generating and storing, in response to detecting creation of a record, two values for the record, at least a first of the two values indicating a time of the creation of the record;
updating, in response to detecting a modification of the record, the first value while leaving the second of the two values constant;
determining, in response to identifying multiple versions of the record, which of the multiple versions of the record is a current version of the record based on the first value; and
sending data associated with the current version of the record to at least one device not having the current version.

16. The computer readable medium of claim 15, further comprising program code for:
determining whether the record is a newly created record or a modification of an existing record based on whether the two values for the record have a same value; and
identifying, in response to determining that the record is a modification of the existing record, the existing record based on the second value.

17. The computer readable medium of claim 15, wherein the program code for generating the two values for the record comprises program code for generating the two values as globally unique timestamps that, for the creation of the record, are set to a same value.

18. The computer readable medium of claim 15, wherein the program code for updating the first value comprises program code for indicating a time of the modification of the record the record in the updated first value.

19. The computer readable medium of claim 15, further comprising program code for:
in response to detecting the creation of the record, identifying a user device on which the record was created and saving the record; and
after generating the two values for the record, sending a confirmation of the record being saved to the identified user device.

20. The computer readable medium of claim 15, wherein the program code for sending data associated with the current version of the record to at least one device not having the current version comprises program code for:
determining at least one other user device for which records are to be synchronized with, and
sending data associated with the record to the at least one other user device.
